(19) United States
(12) Patent Application Publication
(10) Pub. No.: US 2014/0366720 A1
(43) Pub. Date: Dec. 18, 2014

(54) METHOD AND SYSTEM FOR REMOVING CARBON DIOXIDE FROM FLUE GASES

(71) Applicant: Johannes Menzel, Waltrop (DE)

(72) Inventor: Johannes Menzel, Waltrop (DE)

(73) Assignee: THYSSENKRUPP INDUSTRIAL SOLUTIONS GMBH, Beckum (DE)

(21) Appl. No.: 14/241,174

(22) PCT Filed: Aug. 6, 2012
(86) PCT No.: PCT/EP2012/065340

§ 371 Date: Apr. 7, 2014

(30) Foreign Application Priority Data
Aug. 30, 2011 (DE) 102011053120.3

(51) Int. Cl. B01D 53/14

(52) U.S. Cl. CPC B01D 53/1425; B01D 53/1475; B01D 2257/504
USPC 95/21; 96/234; 96/242

(57) ABSTRACT

A method and system for removing carbon dioxide from flue gas emitted by a fossil fuel operated power plant. In the method and system, carbon dioxide is removed from the flue gas by an absorption process using a scrubbing liquid. The charged scrubbing liquid is regenerated in a desorption process. At least some of the energy required for the regeneration process is fed using low-pressure steam that is withdrawn from the steam-water circuit of the power plant before entering a low-pressure steam turbine. The low-pressure steam is fed to an intermediate steam turbine. The low-pressure steam is expanded to a discharge pressure of less than 3.5 bar and is then fed to the desorption process. The pressure for the desorption process is adjusted by a regulation device in accordance with the discharge pressure from the intermediate steam turbine.

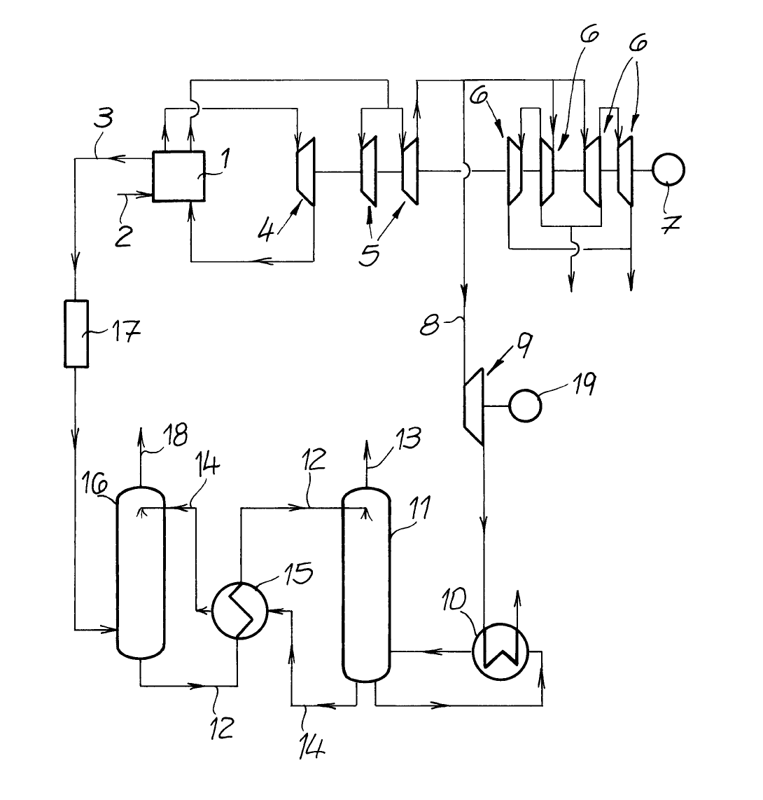

The invention relates to a method and a system for removing carbon dioxide from a flue gas of a power plant operated with fossil fuels, carbon dioxide being removed from the flue gas by means of an absorption process, using a scrubbing liquid, and the laden scrubbing liquid being regenerated in a desorption process, at least part of the energy required for regeneration being delivered via low-pressure steam which is drawn off from the steam/water circuit of the power plant before entry into a low-pressure steam turbine, and the low-pressure steam being delivered to a topping steam turbine in which it is expanded to an outlet pressure of less than 3.5 bar, and the energy of the steam then being delivered to the desorption process.

Carbon dioxide contributes to climate warming as a greenhouse gas. Intensive efforts are therefore made to reduce the carbon dioxide which is released in power plants during the combustion of fossil fuels. The separation of CO₂ after combustion is designated as postcombustion technology. By virtue of decade-long operational experience, postcombustion technologies that are based on flue gas scrubbing are especially successful in particular in the separation of carbon dioxide.

Flue gases occur during the combustion of fossil fuels in power plants at atmospheric pressure. The CO₂ content in this case amounts to 3 to 13% by volume. CO₂ partial pressures of only 0.03 to 0.13 bar are therefore obtained. At such low CO₂ partial pressures, scrubbing liquids which possess as high an uptake capacity as possible are required. Preferably, therefore, scrubbing liquids which remove carbon dioxide from the flue gas by means of chemical absorption are employed. For this purpose, for example, monoethanolamine (MEA), diethanolamine (DEA) or methyldiethanolamine (MDEA) may be used.

The scrubbing liquid laden with CO₂ is regenerated in a desorption process in which the carbon dioxide is expelled by the delivery of thermal energy. For this purpose, the scrubbing liquid is heated to boiling temperature. The boiling temperature depends on the pressure at which the desorption process is operated.

Subsequently, the regenerated scrubbing liquid is delivered once again to the absorption process. The carbon dioxide released in the desorption process is delivered for storage. Storage may take place as sequestration in underground layers of rock. The major benefit of the postcombustion separation technology by chemical absorption is that conventional power plants can be retrofitted with a refined and successful technology without much outlay. The disadvantage of this method is the high outlay in energy terms for regenerating the scrubbing liquid. In a coal-fired power plant, therefore, an efficiency loss of about 13 percentage points due to subsequent CO₂ removal is expected. It is only economically viable to employ the method if there is a marked reduction in this efficiency loss.

One procedure for lowering the additional energy demand is to integrate the CO₂ separation process into the water/steam circuit of the power plant. The steam generated by means of a steam boiler is delivered to a steam turbine unit. This unit comprises high-pressure turbines and low-pressure turbines. Medium-pressure turbines may also be connected between the high-pressure turbines and low-pressure turbines. The turbines may be independent machines or be a machine which is subdivided into a high-pressure, a medium-pressure and a low-pressure part.

At least part of the energy required for regenerating the scrubbing liquid is delivered via low-pressure steam which is drawn off from the steam/water circuit of the power plant. Low-pressure steam is understood to mean steam which is drawn off before entry into the low-pressure steam turbines of the power plant. The low-pressure steam has, as a rule, a pressure of 5 to 6 bar. The low-pressure steam is also designated hereafter as LP steam.

The LP steam is delivered to a condensation heat exchanger which is connected to the sump of a desorption column. The LP steam condenses and transfers heat energy to the scrubbing liquid in the desorption column. In order to ensure a sufficiently high temperature difference for heat transfer, the desorption column is operated at a pressure of about 2 bar. At this pressure, the boiling temperature of the scrubbing liquid amounts to about 120° C.

WO 2009/076 575 A2 discloses a method in which steam is introduced into a turbine cascade, and upstream of a low-pressure booth steam is branched off and delivered to a topping turbine. The steam emerging from the topping turbine is used to regenerate an absorbent, by means of which acid gases have been separated from an exhaust gas stream. Furthermore, EP 2 286 894 A1 discloses a method in which a plurality of turbines are connected in series and steam is branched off upstream of a low-pressure turbine. The branched-off steam is delivered to a topping turbine, whereupon the steam emerging from the topping turbine at a pressure of 1.5 to 20 bar is used to treat an absorbent laden with acid gases. According to EP 2 286 894 A1, a checking device for stabilizing the outlet pressure of the steam leaving the topping turbine is provided. However, the efficiency of the method and apparatuses known from the prior art needs to be improved.

The object of the invention is to reduce the efficiency loss of a power plant which is due to subsequent CO₂ scrubbing.

The object of the invention and the solution for achieving this object are a method of the type initially mentioned, which is characterized in that the method has a regulating device which sets the pressure of the desorption process as a function of the outlet pressure of the topping turbine.

According to the invention, the low-pressure steam is delivered to a topping steam turbine in which it is expanded to an outlet pressure of less than 3.5 bar. The energy of the steam is subsequently delivered to the desorption process.

According to the invention, the method comprises a topping steam turbine. In contrast to conventional methods, the low-pressure steam is not conducted directly to the desorption process, but instead is first delivered to this topping steam turbine in which expansion to an outlet pressure of less than 3.5 bar takes place. In an advantageous variant of the method, expansion to an outlet pressure of less than 3 bar, preferably of less than 2.5 bar, especially of less than 2 bar, takes place. It proves to be especially beneficial if the steam leaves the topping steam turbine at a pressure of less than 1.5 bar.

In an especially advantageous version of the invention, the topping steam turbine is designed as a low-pressure steam turbine. This further low-pressure steam turbine can be integrated into the turbine part of the power plant. All the turbines, including the topping steam turbine, set in rotation a common shaft which drives a common generator.

In another variant, the topping steam turbine is designed as an independent machine. In this case, the topping steam turbine sets in rotation a dedicated shaft which drives a dedicated generator or a machine. For example, a compressor or a pump may be driven by the topping steam turbine.

After expansion, the steam is delivered to the reboiler of the desorption column. A reboiler in the context of the invention is to be understood to be a condensation heat exchanger which is connected to the sump of a desorption column. The steam condenses and transfers heat to the scrubbing liquid laden with CO₂.

As a result of the expansion of the LP steam in the topping steam turbine, current is additionally generated. Since the steam has a lower pressure and therefore a lower temperature downstream of the topping steam turbine, as compared with conventional methods, the temperature in the desorption column is also lowered in order to ensure effective heat transfer. This ensures that the driving temperature gradient is sufficiently high. The temperature is lowered by reducing the pressure at which the desorption column is operated.

According to the invention, the pressure in the desorption column is set automatically by means of a regulating device as a function of the outlet pressure of the topping steam turbine. For this purpose, for example, a PID controller may be used.

Depending on the outlet pressure of the topping steam turbine, the pressure in the desorption column is adapted. The boiling temperature of the scrubbing liquid and therefore the temperature to which the sump of the desorption column must be heated are set according to the pressure in the desorption column. The following table shows by way of example an assignment of process parameters.

TABLE 1
Process parameters

| Outlet pressure | | |
|---|---|---|
| topping steam | Pressure | Temperature sump |
| turbine | desorption column | desorption column |
| p_{turbine} <3.5 bar | p_{column} <2 bar | tₛᵤₘₚ <120° C. |
| p_{turbine} <3 bar | p_{column} <1.5 bar | tₛᵤₘₚ <110° C. |
| p_{turbine} <2.5 bar | p_{column} <1.1 bar | tₛᵤₘₚ <105° C. |
| p_{turbine} <1.5 bar | p_{column} <1 bar | tₛᵤₘₚ <95° C. |

The more the steam in the topping steam turbine is expanded, the higher the amount of electrical energy generated. The lower the boiling temperature of the scrubbing liquid, the less thermal energy is required for heating the desorption column.

As well as the additional recovery of electrical energy and as well as the lower thermal energy necessary for heating the desorption column, the method according to the invention affords positive energy effects which reduce the efficiency loss caused by subsequent CO₂ scrubbing. Thus, the desorption heat of carbon dioxide decreases with the falling boiling temperature. The desorption heat has the largest share of the energy demand in the regeneration of the scrubbing liquid. This is demonstrated by the following examples:

### EXAMPLE 1

Energy for the regeneration of monoethanolamine (MEA),
at 120° C., 110 kJ/mol of CO₂ are required
at 40° C., only 85 kJ/mol of CO₂ are required.

In the case of tertiary amines, this difference is even greater, as shown by the following example:

### EXAMPLE 2

Energy for the regeneration of methyldiethanolamine (MDEA),
at 120° C., 110 kJ/mol of CO₂ are required
at 40° C., only 70 kJ/mol of CO₂ are required.

The same applies in a similar way to potash solutions:

### EXAMPLE 3

Energy for the regeneration of potash solutions,
at 120° C., 50 kJ/mol of CO₂ are required
at 40° C., only 27 kJ/mol of CO₂ are required.

In all three examples, the energy demand for regenerating the scrubbing liquid falls.

In the method according to the invention, a further positive energy effect is obtained in that the specific condensation heat released in the condensation heat exchanger increases with a decreasing pressure.

In conventional methods, LP steam of 5.5 bar is condensed in the reboiler. In this case, a specific condensation heat of 2097 kJ/kg is released. If the LP steam is reduced to an outlet pressure of 2.5 bar when a topping steam turbine is used, at this pressure the specific condensation heat amounts to 2225 kJ/kg. A steam saving of 6% is thereby obtained.

The regenerated scrubbing liquid is used once again for the absorption of carbon dioxide. The absorption process is carried out at low temperatures. The regenerated scrubbing liquid therefore has to be cooled. By contrast, the scrubbing liquid laden with CO₂ has to be heated for regeneration in the desorption column. For this purpose, a heat exchanger is used, which transfers heat from the hot regenerated scrubbing liquid to the cold laden scrubbing liquid. Since the boiling temperature in the scrubbing liquid is lower in the method according to the invention, only a relatively small heat quantity has to be transferred from the hot regenerated scrubbing liquid to the cold laden scrubbing liquid. The exchange surface required for heat exchange is consequently markedly smaller, with the result that more compact and more cost-effective heat exchangers can be employed.

The carbon dioxide expelled from the scrubbing liquid is compressed for its subsequent storage, for example in the context of sequestration. As a result of the method according to the invention, the pressure at which the carbon dioxide leaves the desorption column is lowered. This entails an additional outlay in terms of compression. However, the additional outlay in terms of compression is markedly lower, as compared with the energy saving effects described above.

The object of the invention is also a system as claimed in claim 8 for carrying out the method described. Advantageous refinements of the system are described in claims 9 to 11.

Further features and advantages of the invention will be gathered from the description of an exemplary embodiment by means of a drawing and from the drawing itself. The single FIGURE shows a method and system diagram for CO₂ removal from the flue gas of a coal-fired power plant.

A coal-fired power plant is illustrated diagrammatically in the FIGURE. Air and coal are delivered to a boiler 1, as indicated by the arrow 2. A flue gas 3 containing carbon dioxide leaves the boiler 1. Steam is generated in the boiler 1. The water/steam circuit of the power plant comprises a high-pressure steam turbine 4, two medium-pressure steam turbines 5 and four low-pressure steam turbines 6. A generator 7 is arranged at the end of the turbine section.

A substream 8 of low-pressure steam is branched off upstream of the low-pressure steam turbines 6. The low-pressure steam has a pressure of 5.5 bar. The substream 8 of low-pressure steam is expanded in a topping steam turbine 9 to a pressure of 1.5 bar. The expanded steam is delivered to a condensation heat exchanger 10 designed as a reboiler. In the condensation heat exchanger 10, the steam condenses at 1.5 bar.

In the exemplary embodiment, the topping steam turbine 9 is designed as an independent machine. The topping steam turbine 9 sets in rotation a dedicated shaft which drives a dedicated assembly 19. The assembly 19 is a generator in the exemplary embodiment.

The condensation heat exchanger 10 heats up the sump of a desorption unit 11. In the exemplary embodiment, the desorption unit 11 is a desorption column. A stream of scrubbing liquid 12 laden with CO₂ is delivered to the desorption unit 11. The carbon dioxide is expelled in the desorption unit 11 and is discharged at the head of the column in a line 13. The discharged CO₂ is delivered for compression.

The regenerated scrubbing liquid 14 is discharged at the bottom of the column and is conducted via a heat exchanger 15. The hot regenerated scrubbing liquid 14 gives off heat to the cold scrubbing liquid 12 laden with CO₂ which is drawn off at the bottom of an absorption unit 16 designed as a column.

The flue gas 3 is delivered to the absorption unit 16 after it has run through flue gas treatment 17. In the absorption unit 16, carbon dioxide is scrubbed out of the flue gas by a scrubbing liquid 14. The flue gas 18 purified of CO₂ is discharged at the head of the absorption unit 16.

The substream 8 of LP steam is expanded in the intermediate turbine from a pressure of 5.5 bar to an outlet pressure of 1.5 bar. At this pressure, the steam condenses in the condensation heat exchanger 10. In order to ensure a sufficiently high temperature gradient for heat transfer in the condensation heat exchanger 10, a pressure of 1 bar is set in the desorption unit 11. A boiling temperature of the scrubbing liquid of 95° C. is consequently set at the sump of the desorption unit 11.

The expansion of the LP steam via the additional topping steam turbine 9 from 5.5 bar to 1.5 bar and subsequent condensation at 1.5 bar in the condensation heat exchanger 10 of the desorption unit 11, the desorption unit 11 being operated at an absolute pressure of 1 bar, afford a reduction in losses in current generation of about 27%, as compared with methods according to the prior art. In this case, the CO₂ removal with a specific energy outlay of 3400 kJ/kg of removed CO₂ was calculated. This is the specific energy consumption value for an MEA solution with 30% by weight of monoethanolamine. The saving due to a reduced desorption temperature and to a lower desorption heat is not yet taken into account in this case.

In the method according to the invention, the desorption unit 11 is operated at a pressure of 1 bar, in contrast to methods according to the prior art in which a pressure of 2 bar is set in the desorption column. The additional compression of the expelled CO₂ gas from a pressure of 1 bar to 2 bar is already included in the calculated potential for savings of 27%.

1. A method for removing carbon dioxide from a flue gas of a power plant operated with fossil fuels, carbon dioxide being removed from the flue gas by means of an absorption process, using a scrubbing liquid, and the laden scrubbing liquid being regenerated in a desorption process, at least part of the energy required for regeneration being delivered via low-pressure steam which is drawn off from the steam/water circuit of the power plant before entry into a low-pressure steam turbine, the low-pressure steam being delivered to a topping steam turbine in which it is expanded to an outlet pressure of less than 3.5 bar, and the energy of the steam then being delivered to the desorption process, wherein the method has a regulating device which sets the pressure of the desorption process as a function of the outlet pressure of the topping steam turbine.

2. The method as claimed in claim 1, wherein the low-pressure steam in the topping steam turbine is expanded to an outlet pressure of less than 3 bar, preferably of less than 2.5 bar, especially of less than 2 bar.

3. The method as claimed in claim 1, wherein the steam expanded in the topping steam turbine is delivered to a condensation heat exchanger, by means of which energy is transferred to the desorption process.

4. The method as claimed in claim 1, wherein the topping steam turbine is integrated into the turbine part of the power plant, the topping steam turbine, together with the steam turbines of the power plant, driving a common generator.

5. The method as claimed in claim 1, wherein the topping steam turbine drives a dedicated generator or a machine.

6. The method as claimed in claim 1, wherein a temperature of the desorption process is adopted as a regulating parameter.

7. The method as claimed in claim 6, wherein the temperature in the sump of a desorption column is adopted as a regulating parameter.

8. A system for carrying out the method as claimed in claim 1, with
an absorption unit in which carbon dioxide can be removed from the flue gas, using a scrubbing liquid, and
a desorption unit for regenerating the laden scrubbing liquid,
at least part of the energy required for regeneration being deliverable via low-pressure steam which is drawn off from the steam/water circuit of the power plant before entry into a low-pressure steam turbine, the system having a topping steam turbine which is arranged upstream of the desorption unit and in which the drawn-off low-pressure steam can be expanded to an outlet pressure of less than 3.5 bar, and a device being provided for delivering the energy of the steam to the desorption unit, wherein the system comprises a regulating device which sets the pressure in the desorption unit as a function of the outlet pressure of the topping steam turbine.

9. The system as claimed in claim 8, wherein the steam expanded in the topping steam turbine can be delivered to a condensation heat exchanger in order to transfer energy to the desorption unit.

10. The system as claimed in claim 8, wherein the topping steam turbine is integrated into the turbine part of the power plant, the topping steam turbine, together with the steam turbines of the power plant, driving a common main generator.

11. The system as claimed in claim 8, wherein the topping steam turbine drives a dedicated generator or a machine.
